(19) United States
(12) Patent Application Publication
(10) Pub. No.: US 2023/0409155 A1
(43) Pub. Date: Dec. 21, 2023

(54) OPERATION INPUT DEVICE

(71) Applicant: ALPS ALPINE CO., LTD., Tokyo (JP)

(72) Inventors: Satoru TAKIZAWA, Miyagi (JP); Takeshi MASAKI, Miyagi (JP); Takashi SASAKI, Miyagi (JP); Kazuhito OSHITA, Miyagi (JP); Yuzuru KAWANA, Miyagi (JP)

(21) Appl. No.: 18/450,519

(22) Filed: Aug. 16, 2023

Related U.S. Application Data
(63) Continuation of application No. PCT/JP2022/002329, filed on Jan. 24, 2022.

(30) Foreign Application Priority Data
Mar. 16, 2021 (JP) 2021-042582

(51) Int. Cl. G06F 3/044

(52) U.S. Cl. CPC G06F 3/0448; E05B 81/77

(57) ABSTRACT

Operation input device with few gesture operation erroneous detections is provided. Operation input device includes substrate; plurality of detecting electrodes provided on substrate surface; detecting unit detecting capacitance occurring between each detecting electrode and operating body upon operating body being brought close to substrate; and determining unit determining whether gesture operation by operating body has been performed. Detecting electrodes include first and second electrodes of which capacitance values decrease/increase to match amount of movement of operating body when operating body is moved in longer direction. Upon sensing of operation of moving operating body after being stopped relative to detecting electrodes, or operation of stopping operating body after being moved relative to detecting electrodes, gesture operation by operating body is determined to have been performed. Operating body is determined to be stopped when changes in sum of, and ratio between, capacitance values of first and second electrodes are ≤predetermined values.

### CROSS-REFERENCE TO RELATED APPLICATIONS

This application is a continuation application of International Application No. PCT/JP2022/002329, filed on Jan. 24, 2022, and designating the U.S., which is based upon and claims priority to Japanese Patent Application No. 2021-042582, filed on Mar. 16, 2021, the entire contents of which are incorporated herein by reference.

### BACKGROUND

### Technical Field

The present invention relates to an operation input device.

### Description of Related Art

A door handgrip by which a door of, for example, an automobile is opened or closed is provided on the door at the external side of, for example, the automobile. An operation of, for example, opening or closing such a door of, for example, an automobile is performed by touching the door handgrip or by moving a hand brought close to the door handgrip (for example, see Japanese Laid-Open Patent Publication No. 2009-79353, International Publication No. WO 2019/064858, and International Publication No. WO 2019/064859).

### SUMMARY

However, erroneous detection often occurs in response to an operation of touching a door handgrip or simply moving a hand brought close to the door handgrip. Such erroneous detection may unintentionally cause the door to become unlocked.

Hence, an operation input device that can be mounted on, for example, a door handgrip, and into which an input can be entered by a gesture operation that does not cause erroneous detection is demanded.

According to one aspect of an embodiment, a substrate; a plurality of detecting electrodes provided on a surface of the substrate; a detecting unit configured to detect a capacitance that occurs between each of the detecting electrodes and an operating body when the operating body is brought close to the substrate; and a determining unit configured to determine whether a gesture operation by the operating body has been performed or not are provided. The detecting electrodes include a first electrode of which a capacitance value decreases to match an amount of movement of the operating body when the operating body is moved in a longer direction of the detecting electrodes, and a second electrode of which a capacitance value increases to match an amount of movement of the operating body when the operating body is moved in the longer direction of the detecting electrodes. The determining unit determines that the operating body is stopped in a case where changes in a sum of, and a ratio between, the capacitance value of the first electrode and the capacitance value of the second electrode are lower than or equal to, or lower than predetermined values respectively, and determines that the gesture operation by the operating body has been performed in response to sensing of an operation of moving the operating body after a state in which the operating body is stopped relative to the detecting electrodes, or sensing of an operation of stopping the operating body after the operating body is moved relative to the detecting electrodes.

Because inputting of operational information into the disclosed operation input device is based on combination of a stopping state, in which the operating body does not move, with a gesture operation, it is possible to reduce erroneous detection due to the gesture operation.

### BRIEF DESCRIPTION OF THE DRAWINGS

FIG. 1 is a view illustrating a door on which a door handgrip according to a first embodiment is attached;

FIG. 2 is a view illustrating a door handgrip according to the first embodiment;

FIG. 3 is a view illustrating a structure of detecting electrodes of an operation input device according to the first embodiment;

FIG. 4 is a block diagram of the operation input device according to the first embodiment;

FIG. 5 is a drawing illustrating a gesture operation on an operation input device;

FIG. 6 is drawing illustrating a case where a gesture operation is erroneously detected by an operation input device;

FIG. 7 is a drawing illustrating a gesture operation according to the first embodiment;

FIG. 8 is a flowchart (1) of a gesture operation according to the first embodiment;

FIG. 9 is a flowchart (2) of a gesture operation according to the first embodiment;

FIG. 10 is a flowchart (3) of a gesture operation according to the first embodiment;

FIG. 11 is a drawing illustrating a gesture operation according to a second embodiment;

FIG. 12 is a flowchart (1) of a gesture operation according to the second embodiment;

FIG. 13 is a flowchart (2) of a gesture operation according to the second embodiment;

FIG. 14 is a flowchart (3) of a gesture operation according to the second embodiment;

FIG. 15 is a view illustrating a structure of detecting electrodes of an operation input device according to a third embodiment; and

FIG. 16 is a flowchart of a gesture operation according to the third embodiment.

### DETAILED DESCRIPTION

Embodiments will be described below. Descriptions of, for example, the same components will be omitted by denoting them by the same reference numerals.

### First Embodiment

The operation input device according to the first embodiment will be described. The operation input device according to the present embodiment is built in a door handgrip attached on a door of, for example, an automobile. Operational information can be input into the operational input device via the door handgrip.

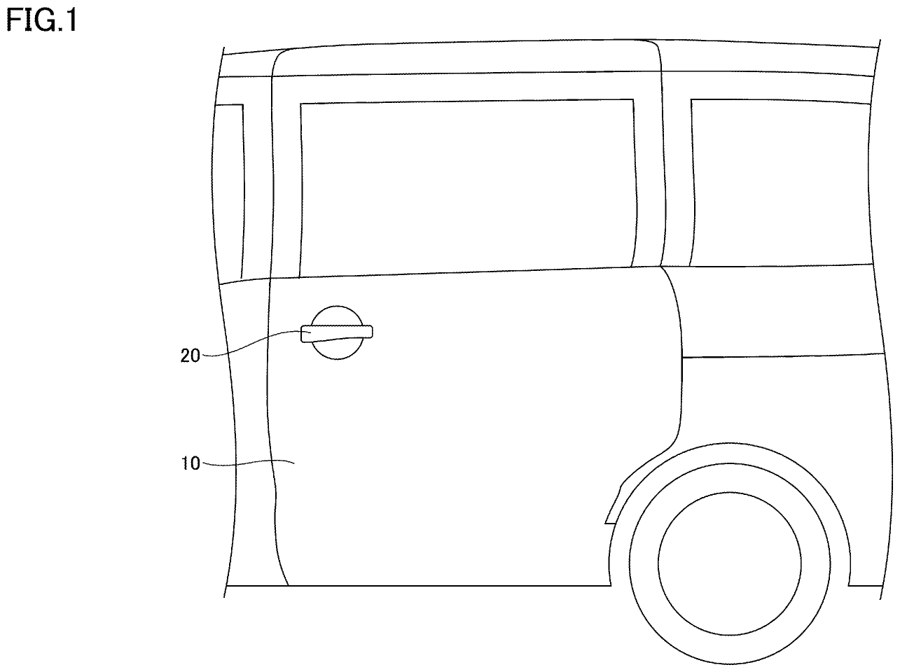

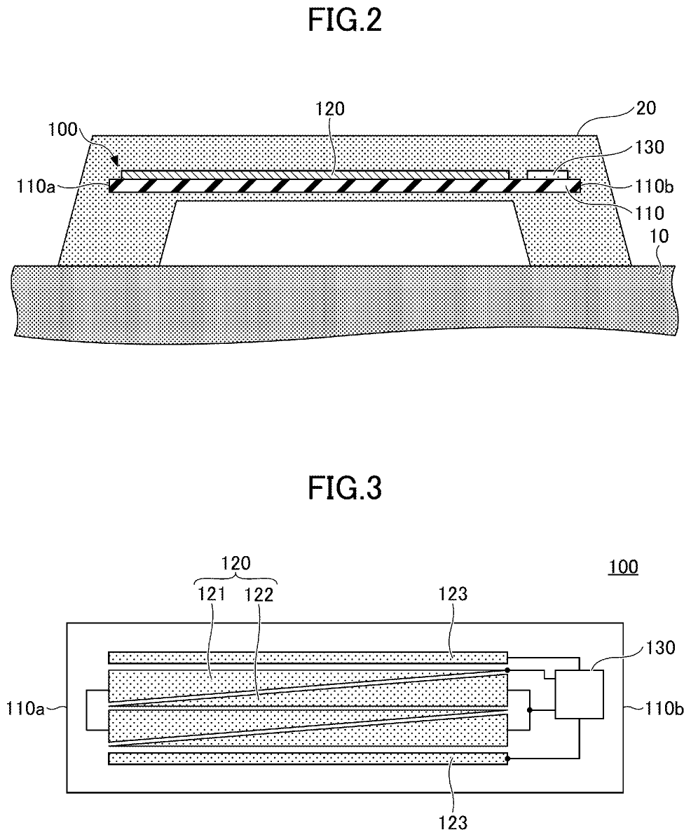

The operation input device according to the present embodiment is built in a door handgrip attached on a door 10 of, for example, an automobile as illustrated in FIG. 1. Specifically, as illustrated in FIG. 2, the operation input device 100 according to the present embodiment is built in the interior of the door handgrip 20. In the operation input device 100 according to the present embodiment, a circuit board 110 formed of an insulating material is provided, and a detecting electrode 120 is provided on a surface of the circuit board 110 that does not face the door 10 such that the detecting electrode 120 extends from one end 110a to the other end 110b of the circuit board 110 having an approximately rectangular shape, i.e., along the longer direction of the circuit board 110. The circuit board 110 is packaged with an integrated circuit 130, and the detecting electrode 120 is coupled to the integrated circuit 130. The integrated circuit 130 may be provided in the interior of, for example, an automobile, that is, may be provided outside the door handgrip 20.

The operation input device 100 according to the present embodiment includes the detecting electrode 120 as illustrated in FIG. 3, and the detecting electrode 120 is formed of a first detecting electrode 121 and a second detecting electrode 122. The first detecting electrode 121 and the second detecting electrode 122 are formed in a triangular shape when seen in a top view perspective. Specifically, the first detecting electrode 121 is formed such that one side of the triangular shape is at the one end 110a of the circuit board 110, and an acute angle of the triangular shape is at the other end 110b, and the width of the triangular shape gradually decreases from the one end 110a to the other end 110b. Two first detecting electrodes 121 having the same shape are provided and coupled to each other.

The second detecting electrode 122 is formed such that an acute angle of the triangular shape is at the one end 110a of the circuit board 110 and one side of the triangular shape is at the other end 110b, and the width of the triangular shape gradually increases from the one end 110a to the other end 110b. Two second detecting electrodes 122 having the same shape are provided and coupled to each other.

In the present embodiment, for example, when a hand is present near the one end 110a, the first detecting electrodes 121 having a larger width detect higher capacitance values, and the second electrodes 122 having a smaller width detect lower capacitance values. When a hand is present near the other end 110b, the first detecting electrodes 121 having a smaller width detect lower capacitance values, and the second detecting electrodes 122 having a larger width detect higher capacitance values.

Hence, when a hand moves from the one end 110a to the other end 110b of the circuit board 110, the capacitance values detected by the first detecting electrodes 121 gradually decrease to match the amount of movement of the hand, and the capacitance values detected by the second detecting electrodes 122 gradually increase to match the amount of movement of the hand.

Hence, it is possible to detect the position at which the hand is present in the longer direction of the detecting electrode 120, based on the capacitance values detected by the first detecting electrodes 121 and the capacitance values detected by the second detecting electrodes 122. Specifically, it is possible to detect the position of the hand based on the ratio between the capacitance values detected by the first detecting electrodes 121 and the capacitance values detected by the second detecting electrodes 122.

Here, even if the distance between the detecting electrode 120 and the hand in a perpendicular direction (roughly, a direction intersecting with a surface of the door 10 perpendicularly) changes, the ratio between the capacitance values detected by the first detecting electrodes 121 and the capacitance values detected by the second detecting electrodes 122 hardly changes. Therefore, it is possible to detect the position of the hand in the longer direction of the detecting electrode 120 almost without being affected by the distance from the detecting electrode 120 in the perpendicular direction. Moreover, even if the position of the hand in the longer direction of the detecting electrode 120 changes, the sum of the capacitance values detected by the first detecting electrodes 121 and the capacitance values detected by the second detecting electrodes 122 hardly changes, so long as the distance between the detecting electrode 120 and the hand in the perpendicular direction is constant. Therefore, by calculating the sum, it is possible to detect the distance between the detecting electrode 120 and the hand in the perpendicular direction.

The sensor shape need not be a triangular shape, and may be any electrode shape that has a tendency that when a hand moves from the one end 110a to the other end 110b of the circuit board 110, the capacitance values detected by the first detecting electrodes 121 gradually decrease to match the amount of movement of the hand, and the capacitance values detected by the second detecting electrodes 122 gradually increase to match the amount of movement of the hand. As illustrated in FIG. 3, shield electrodes 123 that are driven at the ground potential or at the same potential as the detecting electrode may be provided on both sides of the detecting electrode 120 formed of the first detecting electrodes 121 and the second detecting electrodes 122. Moreover, the two first detecting electrodes having the same shape are provided above or below each other in the upward or downward direction of FIG. 3, and coupled in parallel. However, they may be formed as one detecting electrode. The same applies to the second detecting electrodes.

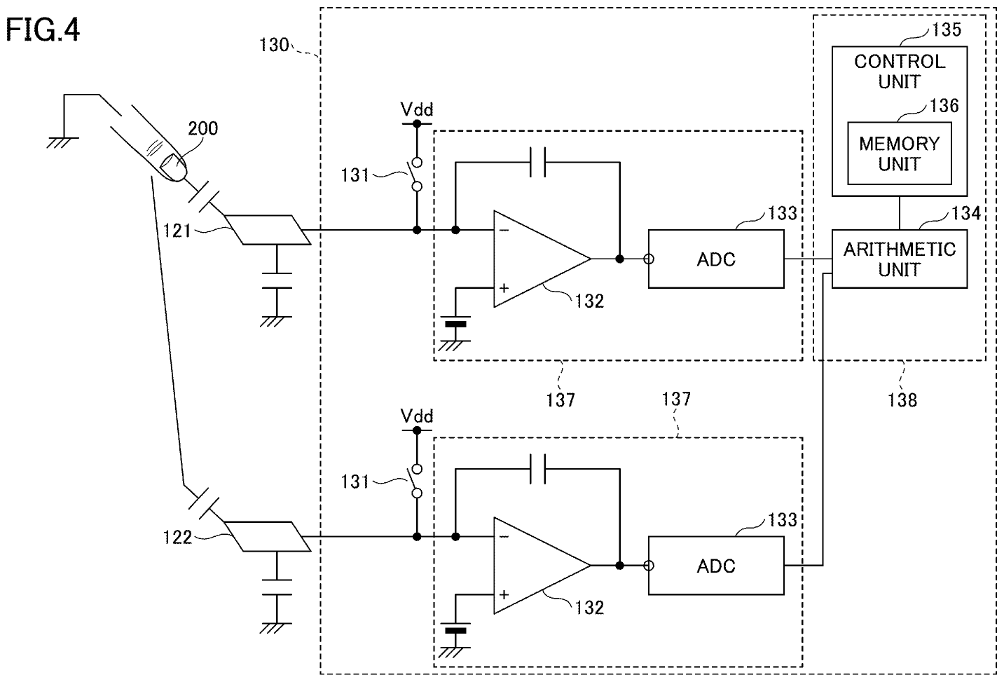

As illustrated in FIG. 4, the integrated circuit 130 includes switches 131 formed of semiconductor elements such as Field Effect Transistors (FETs) between the first detecting electrodes 121 and second detecting electrodes 122, and power supplies Vdd. The two switches 131 are closed at the same time, and a predetermined voltage Vdd is applied for a predetermined time to the first detecting electrodes 121 and the second detecting electrodes 122. Subsequently, the switches 131 are opened at the same time, and the potentials across the first detecting electrodes 121 and the second detecting electrodes 122 are detected. The detected potentials are amplified by amplifiers 132, and are converted from analog signals to digital signals by Analog-to-Digital Converters (ADC, AD converters) 133. An arithmetic unit 134 can calculate a capacitance value between the first detecting electrodes 121 or the second detecting electrodes 122 and a hand 200 based on the digital signal resulting from conversion. The information regarding the calculated capacitance between each of the first detecting electrodes 121 and the second detecting electrodes 122 and the hand 200 is sent to a control unit 135.

Hence, the operation input device 100 according to the present embodiment is formed of the circuit board 110 on which the detecting electrode 120 is formed, and the integrated circuit 130. The integrated circuit 130 includes, for example, the switches 131, the amplifiers 132, the ADCs 133, the arithmetic unit 134, and the control unit 135. A memory unit 136 is provided in the control unit 135. Since an operation by the hand 200 is performed in the present invention, the hand 200 may be described as an operating body. In the present invention, a part of the integrated circuit 130 that is formed of the amplifiers 132 and the ADCs 133 may be described as a detecting unit 137, and a part of the integrated circuit 130 that is formed of the arithmetic unit 134 and the control unit 135 may be described as a determining unit 138.

The operation input device according to the present embodiment can continuously detect the position of the hand 200 based on the information regarding the capacitance between each of the first detecting electrodes 121 and the second detecting electrodes 122 and the hand 200 obtained in the way described above, and can detect a gesture operation by detecting, for example, changes of the position, and the moving speed.

In the description of the embodiments, because the power supply Vdd, the switch 131, and the detecting unit 137 that are coupled to the second detecting electrodes 122 are equal or similar to the switch 131 and the detecting unit 137 that are coupled to the first detecting electrodes 121, they are denoted by the same reference numerals.

The potentials across the first detecting electrodes 121 and the second detecting electrodes 122 are detected by the detecting units 137 provided separately. However, one detecting unit 137 may be provided and driven by time division. In this case, however, it is necessary to time-divisionally drive the detecting unit 137 at time intervals sufficiently shorter than the moving speed of the hand 200.

(Gesture Operation that is Performed Only by Moving a Hand)

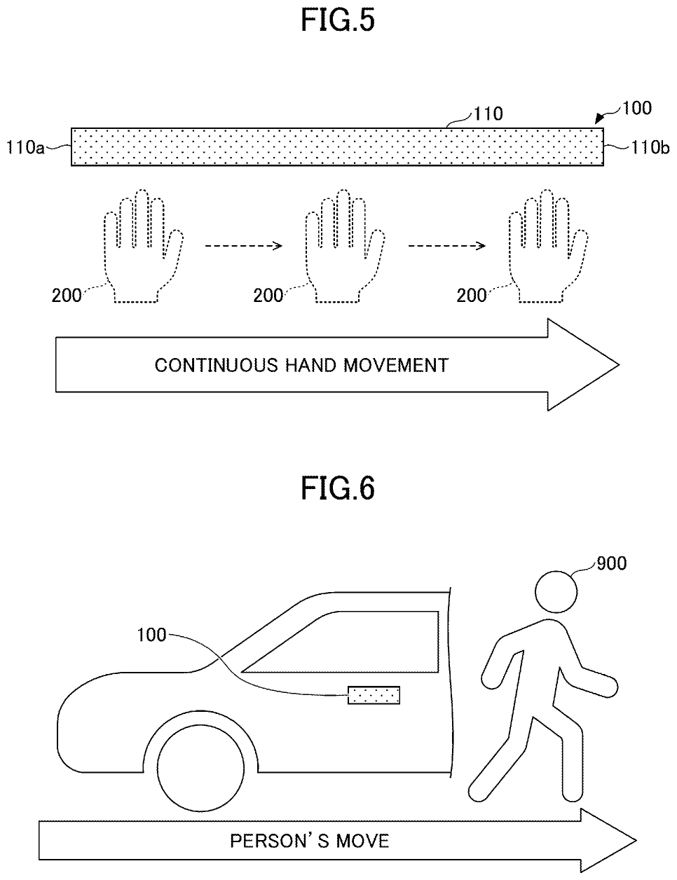

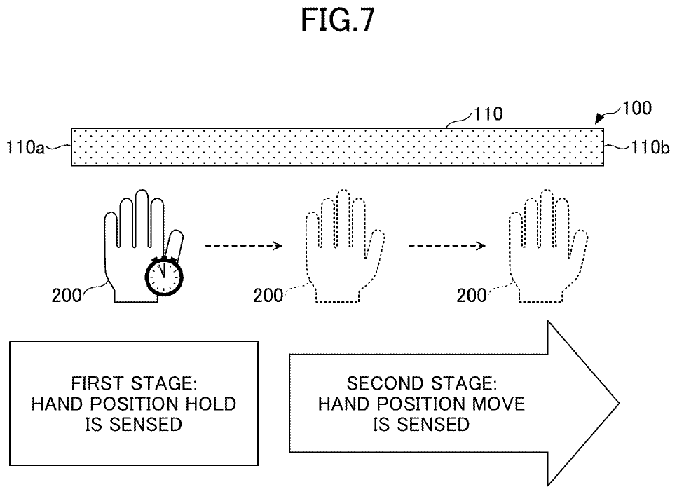

Next, a gesture operation that is performed only by moving a hand will be described. For example, a conceivable inputting method for inputting a gesture operation is to continuously move the hand 200 from the one end 110a to the other end 110b of the circuit board 110 over the operation input device 100, as illustrated in FIG. 5. FIG. 5 illustrates that the hand 200 moves along positions that are offset from positions at which the hand 200 would face the circuit board 110. This is for facilitating understanding, and the hand 200 actually moves along positions that each exists in the direction perpendicular to the circuit board 110, i.e., over the door handgrip 20, and face the door handgrip 20 while being spaced apart by a certain distance. The same applies in FIG. 7 mentioned below. In this case, even when a person 900 merely passes closely by the automobile on which the door handgrip mounted with the operation input device 100 is attached as illustrated in FIG. 6, it would be erroneously recognized that a gesture operation has been performed, and consequently a locked door may become unlocked. Hence, an operation input device that is free from erroneous recognition is demanded. In the present specification, unless defined in particular, positions or coordinates indicate positions in a direction heading from the one end 110a to the other end 110b of the circuit board 110, i.e., positions in the longer direction of the detecting electrode 120. Distances indicate distances in the direction perpendicular to the circuit board 110.

### (Gesture Operation According to the Present Embodiment)

Next, a gesture operation according to the present embodiment will be described. A gesture operation according to the present embodiment is performed with respect to the operation input device 100 according to the present embodiment. Specifically, as illustrated in FIG. 7, first, at the first stage, the hand 200 is brought close to the one end 110a of the operation input device 100 according to the present embodiment, and a state in which the movement of the hand 200 is stopped is retained for a predetermined time (a hold operation). At the second stage after the predetermined time has passed, the hand is moved to the other end 110b (a swipe operation). Operational information is input into the operation input device 100 according to the present embodiment by such a gesture operation as described, to perform, for example, operations of unlocking a door, or moving or closing a sliding door. A stopping operation of not moving the hand 200 in any direction is an operation that is typically not performed during an inputting operation. By combining a stopping operation with a gesture operation as in the present example, it is possible to minimize unintentional erroneous operations on the sliding door.

In the present embodiment, a sampling frequency at which a hold operation is sensed (i.e., a sensing frequency per time) may be lower than a sampling frequency at which a swipe operation is sensed. This is because a high sampling frequency is preferred for a swipe operation in which a movement of a hand is to be sensed, whereas a low sampling frequency is not problematic for a hold operation in which a stationary state of a hand is to be sensed.

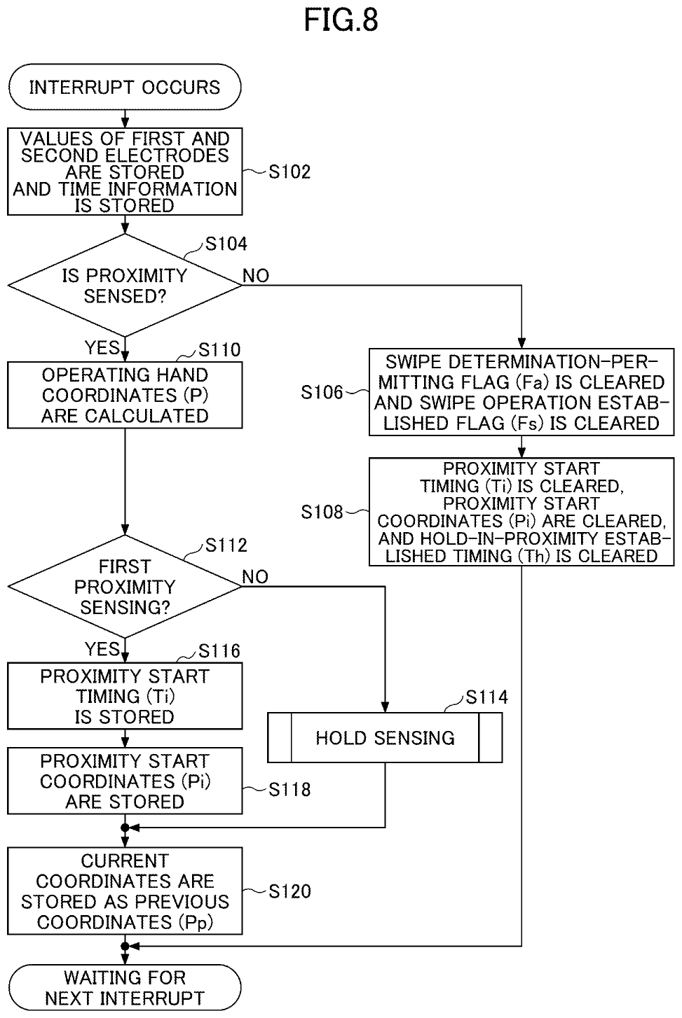

The gesture operation according to the present embodiment will be described more specifically with reference to FIG. 8 to FIG. 10. In the present invention, an operation by which the position and the distance of the hand 200 with respect to the operation input device 100 would not change after the hand 200 is brought close to the operation input device 100 may be described as hold or a hold operation, or a stopping operation. An operation by which the hand 200 is moved with respect to the operation input device 100 under a predetermined requirement after the hand 200 is brought close to the operation input device 100 may be described as a swipe or a swipe operation. For example, determination on the gesture operation according to the present embodiment, which also includes a stopping operation, is performed by the determining unit 138.

In response to an interrupting event, which occurs when a predetermined timing corresponding to the sampling frequency comes, the present process starts. In response, first, in the step S102, the capacitance values of a first electrode and a second electrode are read and stored in a memory. The reading timing (time information) is also stored.

Next, in the step S104, proximity sensing determination for determining whether a hand is in proximity of the operation input device 100 according to the present embodiment or not is performed. Specifically, when a hand is in proximity of the operation input device 100, the capacitance values detected by the first detecting electrodes 121 and the second detecting electrodes 122 of the operation input device 100 become higher than the capacitance values when nothing is in proximity. Hence, when the sum of the capacitance values detected by the first detecting electrodes 121 and the capacitance values detected by the second detecting electrodes 122 is higher than a predetermined value, it is determined that the hand 200 is in proximity of the operation input device 100, i.e., the distance between the operation input device 100 and the hand 200 is lower than the predetermined value, and the flow is moved to the step S110. When the sum of the capacitance values detected by the first detecting electrodes 121 and the capacitance values detected by the second detecting electrodes 122 is lower than or equal to the predetermined value, it is determined that the hand 200 is not in proximity of the operation input device 100, i.e., the distance between the operation input device 100 and the hand 200 is higher than or equal to the predetermined value, and the flow is moved to the step S106. Sensing of proximity is described as being determined based on whether the predetermined value is exceeded or not. However, proximity may be defined as being sensed when a state, in which a predetermined threshold is exceeded, continues a predetermined number of times. Alternatively, proximity may be determined as being sensed when a value, which is higher than a predetermined threshold, continues a predetermined number of times while the value is stabilizing in a predetermined range.

Next, in the step S106, a swipe determination-permitting flag (Fa) is cleared, and a swipe operation established flag (Fs) is cleared. The swipe determination-permitting flag (Fa) is a flag indicating that a state, in which swipe operation determination can be performed next, is ready, and in the present first embodiment, is a flag indicating a state in which a hold operation has been established. The swipe operation established flag (Fs) is a flag indicating that a swipe operation has been established.

Next, in the step S108, a proximity start timing (Ti) is cleared, a proximity start coordinates (Pi) are cleared, and a hold-in-proximity established timing (Th) is cleared, to come into a next interrupt waiting state. After, for example, a predetermined time has passed, an interrupt occurs, and the flow is moved to the step S104.

Next, in the step S110, operating hand coordinates (P), which are the coordinates of the position of the hand 200, which has been sensed to be in proximity in the step S104, are calculated based on the capacitance values obtained by the first detecting electrodes 121 and the second detecting electrodes 122 of the operation input device 100. Specifically, as described above, the operating hand coordinates (P) are calculated based on the ratio between the capacitance values detected by the first detecting electrodes 121 and the second detecting electrodes 122 of the operation input device 100. The operating hand coordinates (P) are coordinates indicating a position in the longer direction of the detecting electrode 120.

Next, in the step S112, it is determined whether or not sensing of the hand 200 as being in proximity in the step S104 is the first time proximity is sensed. Specifically, it is determined whether the sum of the capacitance values of the first and second electrodes, the sum being recorded in the last interrupt event, is lower than or equal to a predetermined value or not. When the sum is lower than or equal to the predetermined value, it is determined that this is the first time proximity is sensed. When the sum is higher than the predetermined value, it is determined that this is not the first time proximity is sensed. When sensing of the hand 200 as being in proximity in the step S104 is the first time proximity is sensed, the flow is moved to the step S116. When sensing of the hand 200 as being in proximity in the step S104 is not the first time proximity is sensed, the flow is moved to the step S114. The details of hold sensing in the step S114 will be described below.

Next, in the step S116, the proximity start timing (Ti) at which proximity is sensed in the step S104, i.e., the time information stored in the step S102 before such a step S104 in which proximity is sensed is stored in the memory unit 136.

Next, in the step S118, the operating hand coordinates (P) calculated in the step S110 are stored in the memory unit 136 as proximity start coordinates (Pi). As described above, when hand approaching is sensed for the first time, flags and memories are cleared, and a time and a position are written in the memory.

Next, in the step S120, the operating hand coordinates (P) currently stored is stored as previous coordinates (Pp), to come into a next interrupt waiting state. After, for example, a predetermined time corresponding to the sampling frequency has passed, an interrupt occurs, and the flow is moved to the step S104.

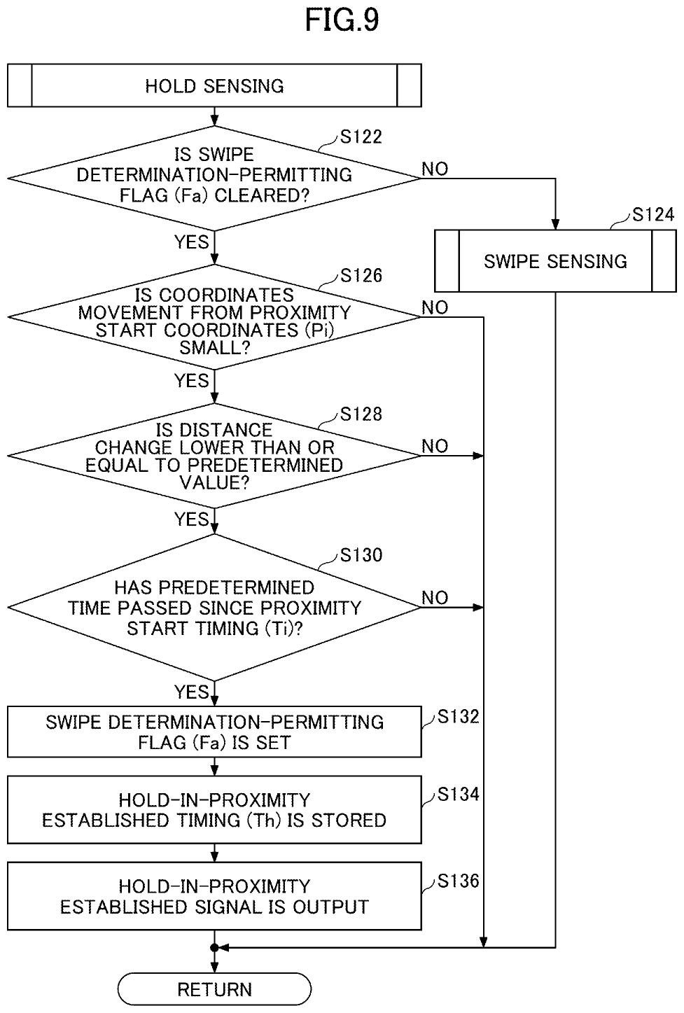

Next, the details of hold sensing in the step S114 will be described with reference to FIG. 9.

Roughly speaking, on the assumption of a state that a hand has already approached, the hold sensing is performed in order to confirm whether this assumed state is a hold state or not.

First, in the step S122, it is determined whether the swipe determination-permitting flag (Fa) is cleared or not. When the swipe determination-permitting flag (Fa) is cleared, the flow is moved to the step S126. When the swipe determination-permitting flag (Fa) is not cleared, i.e., when the swipe determination-permitting flag (Fa) is set, the flow is moved to the step S124. The details of swipe sensing in the step S124 will be described below.

Next, the in the step S126, it is determined whether a coordinates movement from the proximity start coordinates (Pi) is small or not. Specifically, it is determined whether the distance between the operating hand coordinates (P) calculated in the step S110 and the proximity start coordinates (Pi) is small or not, i.e., the distance by which the coordinates move from the proximity start coordinates (Pi) is smaller than or equal to a predetermined distance or not. For the actual calculation, it is determined in the step S126 whether a change in the ratio between the capacitance values of the first detecting electrodes 121 and the second detecting electrodes 122 calculated in the step S110 is lower than or equal to a first predetermined value, e.g., 10%. When the coordinates movement from the proximity start coordinates (Pi) is small, i.e., a change in the ratio between the capacitance values of the first detecting electrodes 121 and the second detecting electrodes 122 is lower than or equal to the first predetermined value, it is determined that the position of the hand 200 has not moved in the direction along the longer direction of the detecting electrode 120, and the flow is moved to the step S128. When the coordinates movement from the proximity start coordinates (Pi) is large, i.e., a change in the ratio between the capacitance values of the first detecting electrodes 121 and the second detecting electrodes 122 is higher than the first predetermined value, it is determined that the position of the hand 200 has moved, and the flow is returned to the flowchart of FIG. 8 and moved to the step S120. It is determined in the step S126 that a change in the ratio between the capacitance values of the first detecting electrodes 121 and the second detecting electrodes 122 is lower than or equal to the first predetermined value or not. However, it may be determined whether a change in the ratio is lower than the first predetermined value or not.

Next, in the step S128, it is determined whether a change in the distance is lower than or equal to a predetermined value or not. Specifically, it is confirmed that the position of the hand 200 has not moved in a direction in which the hand 200 would approach the detecting electrode 120, i.e., that the distance between the operation input device 100 and the hand 200 in the perpendicular direction is lower than or equal to a predetermined value and that a change in the distance is small. As a specific process, when a change in the sum of the capacitance values of the first and second electrodes, the sum being obtained in the previous measurement, is lower than or equal to a second predetermined value, e.g., 10%, it is determined that a change in the distance is lower than or equal to the predetermined value. When a change in the sum of the capacitance values is lower than or equal to the second predetermined value, it is determined that the position of the hand 200 has not moved, and the flow is moved to the step S130. When a change in the sum of the capacitance values is higher than the second predetermined value, it is determined that the position of the hand 200 has moved, and the flow is returned to the flowchart of FIG. 8 and moved to the step S120. In the step S128, it is determined whether a change in the sum of the capacitance values of the first and second electrodes is lower than or equal to the second predetermined value or not. However, it may be determined whether a change in the sum is lower than the second predetermined value or not. Moreover, the determination in the step S128 may be performed based on a change in the capacitance value of either of the first electrode and the second electrode. That is, since it has been confirmed in the step S126 that the change in the ratio between the capacitance values of the first electrode and the second electrode is lower than or equal to the first predetermined value, confirming a change in the capacitance value of either of the electrodes in the step S128 is equivalent to confirming a change in the sum of the capacitance values of the first and second electrodes. Moreover, instead of the step S126 and the step S128, it may be confirmed whether changes in the capacitance values of the first electrode and of the second electrode are lower than or equal to predetermined values. This is because confirming whether changes in the capacitance values of the first electrode and of the second electrode are lower than or equal to predetermined values respectively is equivalent to confirming whether changes in the sum of and the ratio between the capacitance values of the first electrode and the second electrode are lower than or equal to the predetermined values.

Next, in the step S130, it is determined whether a predetermined time, e.g., 300 ms has passed since the proximity start timing (Ti) or not. As a result, it is determined whether the hand 200 has been in an immobile state for the predetermined time or not, i.e., whether a hold operation by the hand has been performed or not. When the predetermined time has passed since the proximity start timing (Ti), it is determined that a hold operation has been performed and that a hold is sensed, and the flow is moved to the step S132. When the predetermined time has not passed since the proximity start timing (Ti), the flow is returned to the flowchart of FIG. 8 and moved to the step S120.

Next, in the step S132, the swipe determination-permitting flag (Fa) is set.

Next, in the step S134, the timing at which the hold is sensed is stored in the memory unit 136 as a hold-in-proximity established timing (Th).

Next, in the step S136, a hold-in-proximity established signal is output, and the flow is returned to the flowchart of FIG. 8 and moved to the step S120.

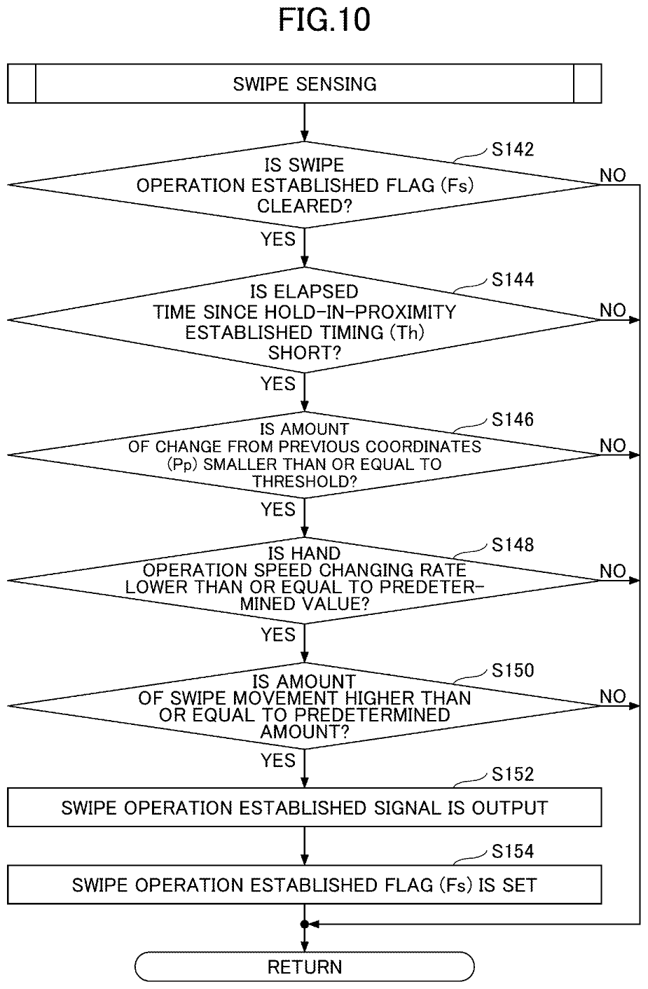

Next, the details of swipe sensing in the step S124 will be described with reference to FIG. 10.

Roughly speaking, the swipe sensing is a process performed after it is confirmed in the step S112 that a hand has already approached and a hold is sensed in the step S122.

First, in the step S142, it is determined whether the swipe operation established flag (Fs) is cleared or not. When the swipe operation established flag (Fs) is cleared, the flow is moved to the step S144. When the swipe operation established flag (Fs) is not cleared, the flow is returned to the flowchart of FIG. 8 via the hold sensing of FIG. 9 and moved to the step S120.

Next, in the step S144, it is determined whether a time that has passed since the hold-in-proximity established timing (Th) is short or not. For example, when the time that has passed is shorter than 3 seconds, it may be determined that the time that has passed is short. When the time that has passed since the hold-in-proximity established timing (Th) is short, the flow is moved to the step S146. When the time that has passed since the hold-in-proximity established timing (Th) is not short, the flow is returned to the flowchart of FIG. 8 via the hold sensing of FIG. 9 and moved to the step S120. That is, the target of determination is only a movement of the hand within a predetermined time since a hold state has been established.

Next, in the step S146, it is determined whether an amount of change of the coordinates position from the previous coordinates (Pp) is smaller than or equal to a threshold or not. This is for excluding possible cases where the change is due to touching of, for example, rain drops, or where the change is noise, the cases being likely when the amount of change of the coordinates position from the previous coordinates (Pp) is larger than the threshold. When the amount of change of the coordinates position from the previous coordinates (Pp) is smaller than or equal to the threshold, the change is determined to be a normal swipe operation, and the flow is moved to the step S148. When the amount of change of the coordinates position from the previous coordinates (Pp) is larger than the threshold, the change is not determined to be a normal swipe operation, and the flow is returned to the flowchart of FIG. 8 via the hold sensing of FIG. 9 and moved to the step S120. In the step S146, it is also determined whether an amount of change in the sum of the first and second electrodes, the sum being detected in the step S128, is lower than or equal to a third predetermined value, e.g., 20%, and whether the distance between the hand 200 and the detecting electrode 120 has hardly changed from the distance during the hold sensing.

Next, in the step S148, it is determined whether the changing rate of the operation speed of the hand that is being detected is lower than or equal to a predetermined value or not. This is for excluding a possible case where the operation is not a normal swipe operation, the case being likely when the changing rate of the operation speed, i.e., the acceleration of the hand that is being detected is higher than the predetermined value. When the acceleration of the operation of the hand that is being detected is lower than or equal to the predetermined value, the operation is determined to be a normal swipe operation, and the flow is moved to the step S150. When the acceleration of the operation of the hand that is being detected is higher than the predetermined value, the operation is not determined to be a normal swipe operation, and the flow is returned to the flowchart of FIG. 8 via the hold sensing of FIG. 9 and moved to the step S120.

Next, in the step S150, it is determined whether an amount of swipe movement, which is the amount of movement of the hand from the proximity start coordinates (Pi), is higher than or equal to a predetermined amount or not. When the amount of swipe movement is higher than or equal to the predetermined amount, the flow is moved to the step S152. When the amount of swipe movement is lower than the predetermined amount, the movement is not determined to be a normal swipe operation, and the flow is returned to the flowchart of FIG. 8 via the hold sensing of FIG. 9 and moved to the step S120. In the step S148 and the step S150, it is also determined whether the distance between the hand 200 and the detecting electrode 120 is in a predetermined range or not, to determine whether the hold operation and the swipe operation have been performed over a line that is spaced apart from the detecting electrode 120 by a certain distance.

Next in the step S152, a swipe operation established signal is output. Then, for example, operations of unlocking a door, or opening or closing a sliding door of the automobile are performed.

Next, in the step S154, the swipe operation established flag (Fs) is set, and the flow is returned to the flowchart of FIG. 8 via the hold sensing of FIG. 9 and moved to the step S120.

### Second Embodiment

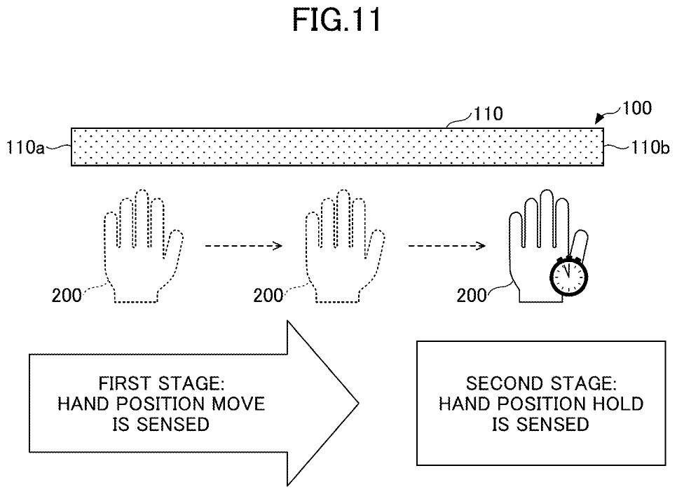

Next, a gesture operation according to the second embodiment will be described. The gesture operation according to the present embodiment is performed on the operation input device 100 according to the first embodiment. Specifically, as illustrated in FIG. 11, first, at the first stage, the hand 200 is brought close to the one end 110a of the operation input device 100 according to the present embodiment, and the hand is then moved to the other end 110b (a swipe operation). Next, at the second stage, a state in which the movement of the hand 200, which has been moved to the other end 110b, is stopped is retained for a predetermined time (a hold operation). Operational information is input into the operation input device 100 according to the present embodiment by such a gesture operation, to perform, for example, unlocking of a door. FIG. 11 illustrates that the hand 200 moves along positions that are offset from positions at which the hand 200 would face the circuit board 110. This is for facilitating understanding, and the hand 200 actually moves along positions that each exist over the circuit board 110, i.e., the door handgrip 20, and face the door handgrip 20 while being spaced apart by a certain distance. A stopping operation of not moving the hand 200 in any direction is an operation that is typically not performed during an inputting operation. By combining a stopping operation with a gesture operation as in the present example, it is possible to minimize unintentional erroneous operations on the sliding door.

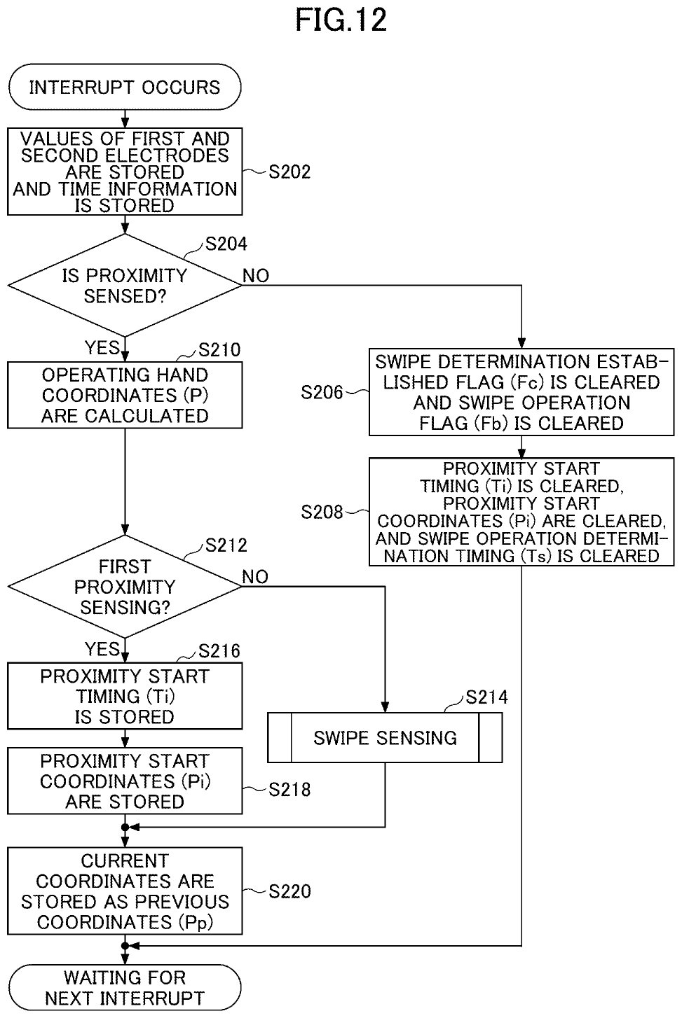

The gesture operation according to the present embodiment will be described more specifically with reference to FIG. 12 to FIG. 14. For example, determination on the gesture operation including a stopping operation according to the present embodiment is performed by the determining unit 138.

First, in the step S202, the capacitance values of the first electrode and the second electrode are read and stored in the memory. The reading timing (time information) is also stored.

Next, in the step S204, proximity sensing determination for determining whether a hand is in proximity of the operation input device 100 according to the present embodiment or not is performed. Specifically, when a hand is in proximity of the operation input device 100, the capacitance values detected by the first detecting electrodes 121 and the second detecting electrodes 122 of the operation input device 100 become higher than the capacitance values when nothing is in proximity. Hence, when the sum of the capacitance values detected by the first detecting electrodes 121 and the capacitance values detected by the second detecting electrodes 122 is higher than a predetermined value, it is determined that the hand 200 is in proximity of the operation input device 100, i.e., the distance between the operation input device 100 and the hand 200 is lower than a predetermined value, and the flow is moved to the step S210. When the sum of the capacitance values detected by the first detecting electrodes 121 and the capacitance values detected by the second detecting electrodes 122 is lower than or equal to the predetermined value, it is determined that the hand 200 is not in proximity of the operation input device 100, i.e., the distance between the operation input device 100 and the hand 200 is higher than the predetermined value, and the flow is moved to the step S206.

Next, in the step S206, a swipe determination established flag (Fc) is cleared, and a swipe operation flag (Fb) is cleared.

The swipe operation flag (Fb) is a flag indicating that a swipe operation has been completed, and in the second embodiment, is a flag indicating that a state, in which hold operation determination can be performed next, is ready. The swipe determination established flag (Fc) is a flag indicating that a swipe operation has been established, and in the second embodiment, is generated in response to completion of a hold operation following completion of a swipe operation.

Next, in the step S208, a proximity start timing (Ti) is cleared, proximity start coordinates (Pi) are cleared, and a swipe operation determination timing (Ts) is cleared, to come into a next interrupt waiting state. After, for example, a predetermined time has passed, an interrupt occurs, and the flow is moved to the step S204.

Next, in the step S210, operating hand coordinates (P), which are the coordinates of the position of the hand 200, which has been sensed to be in proximity in the step S204, are calculated based on the capacitance values obtained by the first detecting electrodes 121 and the second detecting electrodes 122 of the operation input device 100. Specifically, the operating hand coordinates (P) are calculated based on the ratio between the capacitance values detected by the first detecting electrodes 121 and the second detecting electrodes 122 of the operation input device 100. The operating hand coordinates (P) are the coordinates indicating a position in the longer direction of the detecting electrode 120.

Next, in the step S212, it is determined whether or not sensing of the hand 200 as being in proximity in the step S204 is the first time proximity is sensed. Specifically, it is determined whether the sum of the capacitance values of the first and second electrodes, the sum being recorded in the last interrupting event, is lower than or equal to a predetermined value or not. When the sum is lower than or equal to the predetermined value, it is determined that this is the first time proximity is sensed. When the sum is higher than the predetermined value, it is determined that this is not the first time proximity is sensed. When sensing of the hand 200 as being in proximity in the step S204 is the first time proximity is sensed, the flow is moved to the step S216. When sensing of the hand 200 as being in proximity in the step S204 is not the first time proximity is sensed, the flow is moved to the step S214. The details of swipe sensing in the step S214 will be described below.

Next, in the step S216, the proximity start timing (Ti) at which proximity is sensed in the step S204, i.e., the time information stored in the step S202 before such a step S204 in which proximity is sensed is stored in the memory unit 136.

Next, in the step S218, the operating hand coordinates (P) calculated in the step S210 are stored in the memory unit 136 as proximity start coordinates (Pi).

As described above, when hand approaching is sensed for the first time, flags and memories are cleared, and a time and a position are written in the memory.

Next, in the step S220, the operating hand coordinates (P) currently stored is stored as previous coordinates (Pp), to come into a next interrupt waiting state. After, for example, a predetermined time corresponding to the sampling frequency has passed, an interrupt occurs, and the flow is moved to the step S204.

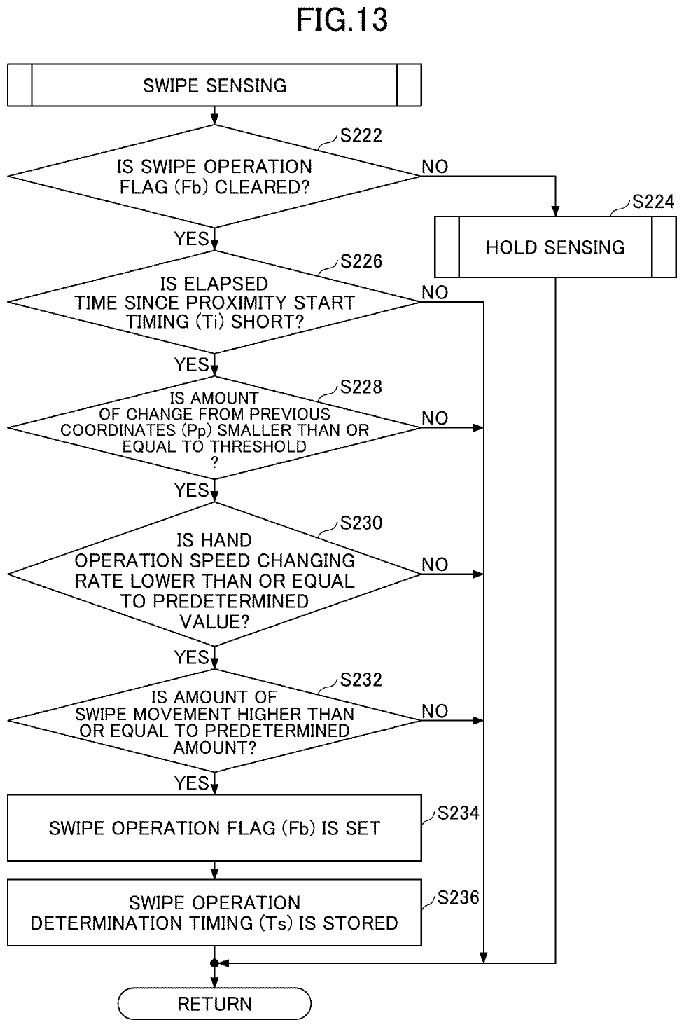

Next, the details of the swipe sensing in the step S214 will be described with reference to FIG. 13.

First, in the step S222, it is determined whether the swipe operation flag (Fb) is cleared or not. When the swipe operation flag (Fb) is cleared, the flow is moved to the step S226. When the swipe operation flag (Fb) is not cleared, i.e., when the swipe operation flag (Fb) is set, the flow is moved to the step S224. The details of hold sensing in the step S224 will be described below.

Next, in the step S226, it is determined whether a time that has passed since the proximity start timing (Ti) is short or not. For example, when the time that has passed is shorter than 3 seconds, it may be determined that the time that has passed is short. When the time that has passed since the proximity start timing (Ti) is short, the flow is moved to the step S228. When the time that has passed since the proximity start timing (Ti) is not short, the flow is returned to the flowchart of FIG. 12 and moved to the step S220.

Next, in the step S228, it is determined whether an amount of change of the coordinates position from the previous coordinates (Pp) is smaller than or equal to a threshold or not. When the amount of change of the coordinates position from the previous coordinates (Pp) is smaller than or equal to the threshold, the change is determined to be a normal swipe operation, and the flow is moved to the step S230. When the amount of change of the coordinates position from the previous coordinates (Pp) is larger than the threshold, the change is determined to be a change due to touching of, for example, rain drops, or noise, and the flow is returned to the flowchart of FIG. 12 and moved to the step S220. In the step S228, it is also determined whether an amount of change in the sum of the first and second electrodes, the sum being detected previously, is lower than or equal to a predetermined value, and whether the distance between the hand 200 and the detecting electrode 120 has hardly changed.

Next, in the step S230, it is determined whether the changing rate of the operation speed of the hand that is being detected is lower than or equal to a predetermined value or not. When the changing rate of the operation speed, i.e., the acceleration of the hand that is being detected is lower than or equal to the predetermined value, the operation is determined to be a normal swipe operation, and the flow is moved to the step S232. When the acceleration of the hand that is being detected is higher than the predetermined value, the operation is not determined to be a normal swipe operation, and the flow is returned to the flowchart of FIG. 12 and moved to the step S220.

Next, in the step S232, it is determined whether an amount of swipe movement, which is the amount of movement of the hand from the proximity start coordinates (Pi), is higher than or equal to a predetermined amount or not. When the amount of swipe movement is higher than or equal to the predetermined amount, the flow is moved to the step S234. When the amount of swipe movement is lower than the predetermined value, the movement is not determined to be a normal swipe operation, and the flow is returned to the flowchart of FIG. 12 and moved to the step S220. In the step S230 and the step S232, it is also determined whether the distance between the hand 200 and the detecting electrode 120 is in a predetermined range or not, to determine whether the swipe operation has been performed over a line that is spaced apart from the detecting electrode 120 by a certain distance.

Next, in the step S234, the swipe operation flag (Fb) is set.

Next, in the step S236, the swipe operation determination timing (Ts) is measured and stored in the memory unit 136, and the flow is returned to the flowchart of FIG. 12 and moved to the step S220.

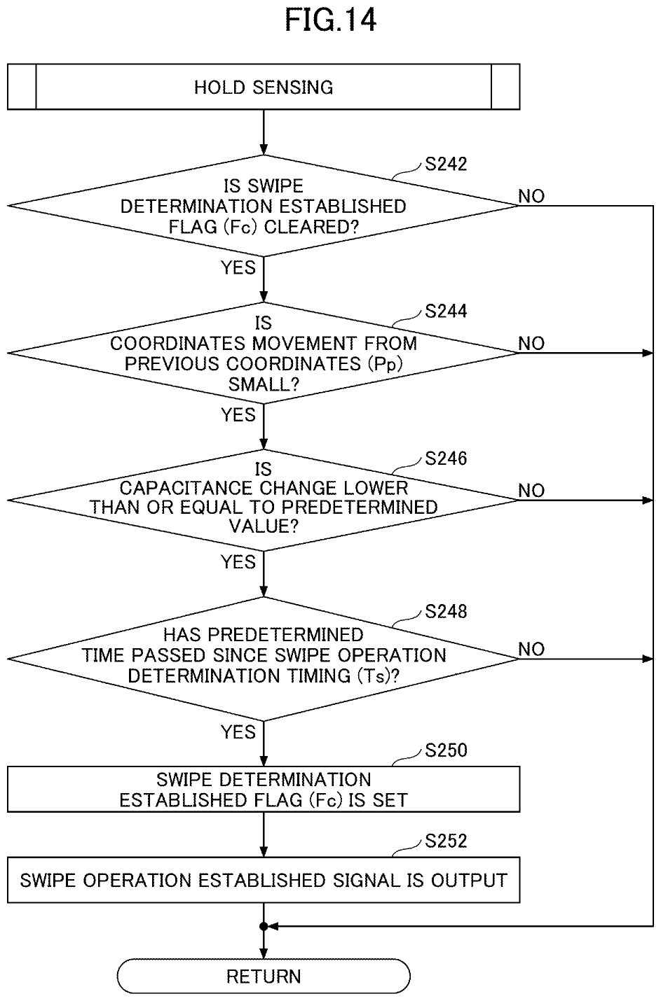

Next, the details of the hold sensing in the step S224 will be described with reference to FIG. 14.

First, in the step S242, it is determined whether the swipe determination established flag (Fc) is cleared or not. When the swipe determination established flag (Fc) is cleared, the flow is moved to the step S244. When the swipe determination established flag (Fc) is not cleared, the flow is returned to the flowchart of FIG. 12 via the swipe sensing of FIG. 13 and moved to the step S220.

Next, in the step S244, it is determined whether a coordinates movement from the previous coordinates (Pp) is small or not. Specifically, it is determined whether the distance between the operating hand coordinates (P) and the previous coordinates (Pp) is small or not, i.e., the distance by which the coordinates move from the previous coordinates (Pp) is smaller than or equal to a predetermined distance or not. For the actual calculation, it is determined whether a change in the ratio between the capacitance values of the first detecting electrodes 121 and the second detecting electrodes 122 is lower than or equal to a first predetermined value, e.g., 10%. When the coordinates movement from the previous coordinates (Pp) is small, i.e., a change in the ratio between the capacitance values of the first detecting electrodes 121 and the second detecting electrodes 122 is lower than or equal to the first predetermined value, it is determined that the position of the hand 200 has not moved in the direction along the longer direction of the detecting electrode 120, and the flow is moved to the step S246. When the coordinates movement from the previous coordinates (Pp) is large, i.e., a change in the ratio between the capacitance values of the first detecting electrodes 121 and the second detecting electrodes 122 is higher than the first predetermined value, it is determined that the position of the hand 200 has moved, and the flow is returned to the flowchart of FIG. 12 via the swipe sensing of FIG. 13 and moved to the step S220. It is also determined in the step S244 whether a change in the ratio between the capacitance values of the first and second electrodes is lower than or equal to the first predetermined value or not. However, it may be determined whether a change in the ratio is lower than the first predetermined value or not.

Next, in the step S246, it is determined whether a change in the distance is lower than or equal to a predetermined value or not. Specifically, it is confirmed that the position of the hand 200 has not moved in a direction in which the hand 200 would approach the detecting electrode 120. As a specific process, when a change in the sum of the capacitance values of the first and second electrodes, the sum being obtained in the previous measurement, e.g., at the end of the swipe operation determination in the step S232, is lower than or equal to a second predetermined value, e.g., 10%, it is determined that a change in the distance is lower than or equal to the predetermined value. When a change in the sum of the capacitance values is lower than or equal to the second predetermined value, it is determined that the position of the hand 200 has not moved, and the flow is moved to the step S248. When a change in the sum of the capacitance values is higher than the second predetermined value, the flow is returned to the flowchart of FIG. 12 via the swipe sensing of FIG. 13 and moved to the step S220. In the step S246, it is determined whether a change in the sum of the capacitance values of the first and second electrodes is lower than or equal to the second predetermined value or not. However, it may be determined whether a change in the sum is lower than the second predetermined value or not. Moreover, the determination in the step S246 may be performed based on a change in the capacitance value of either of the first electrode and the second electrode. That is, since it has been confirmed in the step S244 that the change in the ratio between the capacitance values of the first electrode and the second electrode is lower than or equal to the first predetermined value, confirming a change in the capacitance value of either of the electrodes in the step S246 is equivalent to confirming a change in the sum of the capacitance values of the first and second electrodes. Moreover, instead of the step S244 and the step S246, it may be confirmed whether changes in the capacitance values of the first electrode and of the second electrode are lower than or equal to predetermined values. This is because confirming whether changes in the capacitance values of the first electrode and of the second electrode are lower than or equal to predetermined values respectively is equivalent to confirming whether changes in the sum of and the ratio between the capacitance values of the first electrode and the second electrode are lower than or equal to the predetermined values.

Next, in the step S248, it is determined whether a predetermined time, e.g., 300 ms has passed since the swipe operation determination timing (Ts) or not. As a result, it is determined whether the hand 200 has been in an immobile state for a predetermined time or not, i.e., whether a hold operation by the hand has been performed or not. When the predetermined time has passed since the swipe operation determination timing (Ts), it is determined that a hold operation has been performed and that a hold is sensed, and the flow is moved to the step S250. When the predetermined time has not passed since the swipe operation determination timing (Ts), the flow is returned to the flowchart of FIG. 12 via the swipe sensing of FIG. 13 and moved to the step S220.

Next, in the step S250, the swipe determination established flag (Fc) is set.

Next, in the step S252, a swipe operation established signal is output. Then, for example, operations of unlocking a door, or opening or closing a sliding door of the automobile are performed.

That is, when a swipe operation and a hold operation of the hand have been performed over a line that is spaced apart from the detecting electrode 120 by a certain distance, for example, operations of unlocking a door, or opening or closing a sliding door of the automobile are performed.

### Third Embodiment

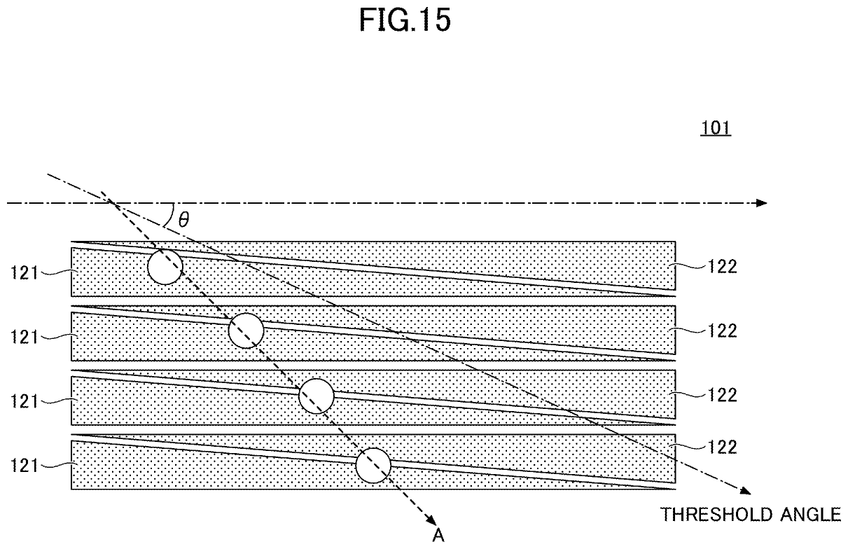

Next, the third embodiment will be described. An operation input device 101 according to the present embodiment includes four first detecting electrodes 121 and four second detecting electrodes 122, which are arranged alternately in the shorter direction as illustrated in FIG. 15.

In the present embodiment, the operation input device 101 according to the present embodiment can perform determination taking into consideration a case where a hand moves obliquely with respect to the operation input device 101. Specifically, a predetermined threshold angle θ is set with respect to the longer direction of the first detecting electrodes 121 and the second detecting electrodes 122, and a movement of a hand in a range smaller than the threshold angle θ is determined to be a normal swipe operation, whereas a movement of a hand in a range greater than the threshold angle θ is not determined to be a normal swipe operation. Specifically, a movement of a hand indicated by a broken line A in FIG. 15 is not determined to be a normal swipe operation because it is a movement in a range greater than the threshold angle θ.

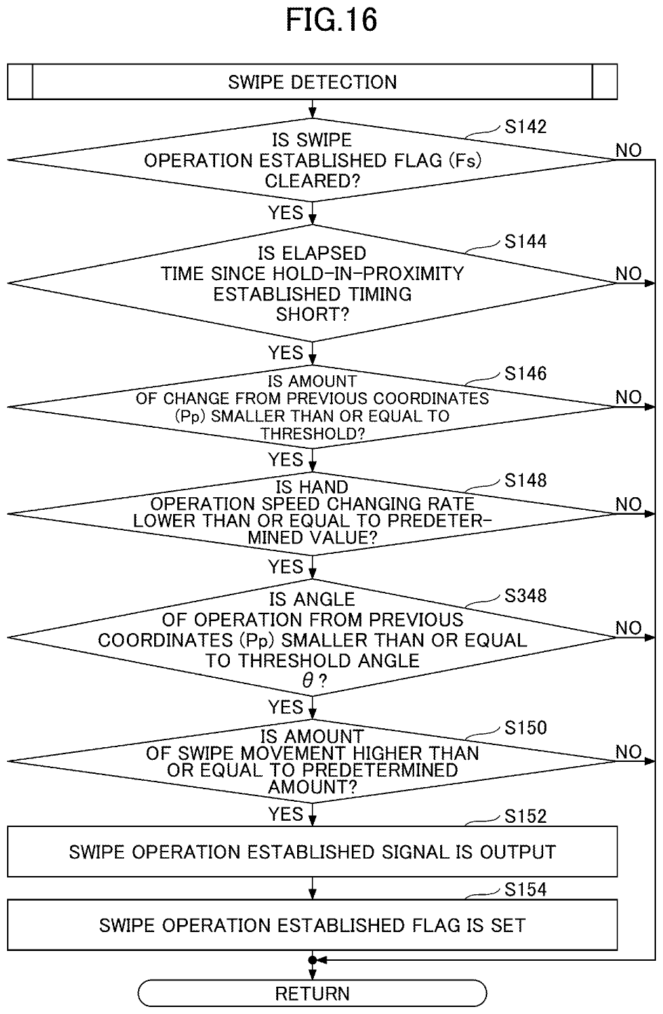

FIG. 16 is a flowchart for swipe sensing in a gesture operation according to the present embodiment. As in the first embodiment, the step S142 to the step S148 are performed in order, and it is then determined whether or not the angle of an operation performed from the previous coordinates (Pp) is smaller than or equal to the threshold angle θ as indicated in the step S348. When the angle of the operation performed from the previous coordinates (Pp) is smaller than or equal to the threshold angle θ, the flow is moved to the step S150, and the step S152 and the step S154 are performed in order. When the angle of the operation performed form the previous coordinates (Pp) is not smaller than or equal to the threshold angle θ, the flow is returned to the flowchart of FIG. 8 via the hold sensing of FIG. 9 and moved to the step S120.

For any particulars other than the foregoing, the same as in the first embodiment applies.

The present embodiment is also applicable to the second embodiment. Specifically, in the swipe sensing in the gesture operation according to the second embodiment, it is determined between the step S230 and the step S232 whether or not the angle of an operation performed from the previous coordinates (Pp) is smaller than or equal to the threshold angle θ, as indicated in the step S348.

In the present example, the circuit board 110, the plurality of detecting electrodes, i.e., the first detecting electrodes 121 and the second detecting electrodes 122 provided on a surface of the circuit board 110, the detecting unit 137 configured to detect the capacitance that occurs between each detecting electrode and the operating body when the operating body, i.e., the hand 200 is brought close to the circuit board 110, and the determining unit 138 configured to determine whether a gesture operation by the operating body has been performed or not are provided. It is determined that a gesture operation by the operating body has been performed in response to sensing of an operation of moving the operating body after a state in which the operating body is stopped relative to the detecting electrodes, or sensing of an operation of stopping the operating body after the operating body is moved relative to the detecting electrodes. That is, for determining a stop, not only a displacement in the swipe direction, but also whether a displacement in the direction of distance from the detecting electrode is lower than or equal to a predetermined value or not are confirmed. A conceivable erroneous determination is due to an unintentional operation, which is scarcely a stop involving no movement in any direction. By performing determination based on combination of a movement with a stop that lasts for a predetermined time as in the present invention, it is possible to reduce erroneous determination due to a movement, and to make erroneous detection less likely to occur.

In the present example, a hold operation (stop) at a position apart from the detecting electrode 120 by a certain distance is a determination target. However, the certain distance may be zero, i.e., a stop that is in a state of touching the surface of the door handgrip may be sensed. Also in this case, when a hand or a body is not stopping, it can be assumed that the hand or the body may bump on the handgrip, accompanied by a great change in the contact area and great changes in the capacitance values. Therefore, by sensing changes in the capacitance values, it is possible to determine whether a determination target is a stop or not even in a touching state. However, it is preferable to sense an operation of a hand at a position apart by a certain distance, because a great change occurs in the capacitance in response to a movement in the distance, which facilitates detection.

Embodiments have been described above in detail. However, the specific embodiments are not intended in a limiting sense, and various modifications and changes are applicable.

What is claimed is:

1. An operation input device, comprising:
a substrate;
a plurality of detecting electrodes provided on a surface of the substrate;
a detecting unit configured to detect a capacitance that occurs between each of the detecting electrodes and an operating body in response to the operating body being brought close to the substrate; and
a determining unit configured to determine whether a gesture operation by the operating body has been performed or not,
wherein the detecting electrodes include a first electrode and a second electrode, where when the operating body is moved in a longer direction of the detecting electrodes, a capacitance value of the first electrode decreases to match an amount of movement of the operating body and a capacitance value of the second electrode increases to match the amount of movement of the operating body, and
the determining unit determines that the operating body is stopped in a case where changes in a sum of, and a ratio between, the capacitance value of the first electrode and the capacitance value of the second electrode are lower than or equal to, or lower than predetermined values respectively, and determines that the gesture operation by the operating body has been performed in response to sensing of an operation of moving the operating body after a state in which the operating body is stopped relative to the detecting electrodes, or sensing of an operation of stopping the operating body after the operating body is moved relative to the detecting electrodes.

2. The operation input device according to claim 1,
wherein the determining unit determines that the gesture operation by the operating body has been performed in response to sensing of an operation of moving the operating body after a state in which the operating body is stopped relative to the detecting electrodes for a predetermined time.

3. The operation input device according to claim 1,
wherein the determining unit determines that the gesture operation by the operating body has been performed in response to sensing of an operation of holding the operating body in a stopping state for a predetermined time after the operating body is moved relative to the detecting electrodes.

4. The operation input device according to claim 1,
wherein the first electrode is formed of a triangular shape of which one side is at one side of the detecting electrodes in the longer direction and of which an acute angle is at an other side of the detecting electrodes in the longer direction, and
the second electrode is formed of a triangular shape of which an acute angle is at the one side of the detecting electrodes in the longer direction and of which one side is at the other side of the detecting electrodes in the longer direction.

5. The operation input device according to claim 2,
wherein the determining unit sets a swipe operation flag in response to sensing of the state in which the operating body is stopped relative to the detecting electrodes for the predetermined time, performs sensing of a swipe operation of the operating body in a case where the swipe operation flag is set, and determines that the gesture operation by the operating body has been performed in response to sensing of the swipe operation.

6. The operation input device according to claim 3,
wherein the determining unit sets a swipe operation flag in response to sensing of a state in which the operating body is swiped relative to the detecting electrodes, and
in a case where the swipe operation flag is set, the determining unit determines that the gesture operation by the operating body has been performed in response to sensing of the operation of holding the operating body in the stopping state for the predetermined time.
